(19) United States
(12) Patent Application Publication
(10) Pub. No.: US 2006/0134312 A1
(43) Pub. Date: Jun. 22, 2006

(54) Wetting system

(75) Inventors: Rob Dekker, Delfgauw (NL); Gerardus Antonius Matthijssen, Abbenbroek (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, Division of Conopco, Inc.

(21) Appl. No.: 11/017,127

(22) Filed: Dec. 20, 2004

(51) Int. Cl. A23G 3/00

(52) U.S. Cl. 426/660

(57) ABSTRACT

A wetting agent which does not present an overall sweet taste, and processes for making and using it. The wetting agent comprises i) at least 40 wt. % or higher of solids, based on total solids in the binder, of one or more fibrous ingredient and ii) at least 1 wt. % of a compound which includes glycerol and/or fatty acid moieties. In a preferred embodiment, the fibrous compound comprises dextrin, most preferably wheat dextrin. In accordance with another embodiment of the invention, the wetting agent includes one or more fibrous ingredients having fewer than 70% glucosidic 1,4 linkages, more than 15% glucosidic 1,6 linkages, especially from 25% to 50%, at least 5% each of glucosidic 1,2 linkages and glucosidic 1,3 linkages and less than 5 wt. % mono- and disaccharides. The wetting agent is useful particularly for savory food bars. The invention is also directed to a process of using the wetting agent by applying it to dried food ingredients to rehydrate the foods and to the rehydrated food ingredients per se.

### BACKGROUND OF THE INVENTION

Consumers tend to prefer fresh foods or, at least, foods made with fresh ingredients. Unfortunately, trends in modern living, not to mention commercial demands of modern food processing, tend to make this goal elusive. Where it is not possible to prepare meals using fresh foods or fresh food ingredients, it is nevertheless desirable that the food and/or ingredients have a taste which strongly resembles that of their fresh cousins.

One convenient form in which food ingredients are provided is as a dried product. Examples of dried food ingredients include dried vegetables and dried meats. Unfortunately, the organoleptic impressions imparted by dried ingredients tend to diverge significantly from those of fresh ingredients. This is due, at least in part, to the decreased levels of moisture in the dried ingredients. As a result, it is desirable to “re-wet” the dried ingredient.

A suitable re-wetting agent should not only replenish moisture removed from the dried ingredient; preferably it does so without significantly altering the normal organoleptic impression of the fresh ingredient. Compositions which have been used as re-wetting agents tend also to be used for other purposes, such as binding agents. Unfortunately, since such binding agents have tended to be sweet, this has limited the usefulness of the “binding/wetting agents.” Consequently, there is a need for a wetting agent which can be used for savory applications, i.e., without imparting sweetness to the dried food. Examples of applications in which the re-wetting agents would be useful include savory food bars since some consumers wish to avoid foods having high sugar levels.

The patent and product literatures contain many mentions of food bars and binders therefor.

As accessed on the www.nutraceuticalsnow.com/issues/back/2002, spring/nutriose.php website on Oct. 18, 2004, Nutriose® FB, available from Roquette Freres of Lestrem, France is said to be a dextrin which is both well tolerated and stable under all acid and heat conditions encountered in food processes. The high tolerance is said to have been demonstrated in a clinical study. It is said to have no sweetness, no aftertaste. Examples of uses given are in drinks, confectionery biscuits, bars, dairy products, pastries and fruit preparations.

Nutriose® FB Technical Bulletin from Roquette America, Inc. indicates that Nutriose® FB is made by dextrinization of wheat starch and that it contains 41% of glucosidic 1,4 linkages, 32% of glucosidic 1,6 linkages, 13% of glucosidic 1,2 linkages and 14% of glucosidic 1,3 linkages. It is recommended as, among other things, a sugar free bulking agent and/or binder. Nutriose® FB is said to be an ideal component for nutrition bars and cereal bars. It is said that Nutriose® FB is especially ideal in the production of no-sugar added or low sugar products. The many listed products also include vegetarian meat substitutes and soups. Nutriose® FB is disclosed to contain less than 0.5% mono- and disaccharides. Synergy with intense sweeteners and low glycemic index are among performance characteristics said to make Nutriose® FB particularly suited for use in nutrition and cereal bars. Nutriose® FB is said to have a glycemic index of 25%.

Fouache et al. U.S. Pat. No. 6,630,586 (Roquette Freres) discloses branched maltodextrins having between 22% and 35% glucosidic 1-6 linkages. The content of glucosidic linkages of 1-6 between 22 and 35% is said to give the branched maltodextrins a character of indigestibility. Certain compounds of the invention are said to be able to play the role of texturizing agents, thickening and/or gelling agents, filling or encapsulating agents, particularly in food products, in pharmaceutical or veterinary products. Acariogenic compositions are disclosed which comprise maltodextrins and polyols which can be glycerine, threitol, erythritol, xylitol, arabitol, ribitol, sorbitol, mannitol, maltitol, maltotriitol, maltotetraitol, lactitol, hydrogenated isomaltulose, and hydrogented starch. The acariogenic composition comprises between 30 and 70 wt. % branched maltodexrins and between 70 and 30% by weight maltitol. Various foodstuffs such as confectionery, pastes to be chewed, preparations based on milk, yoghurts and cakes are mentioned.

According to its abstract, Serpeloni WO 2004/043166 is directed to use of branched chain maltodextrins having between 15 and 35% of 1-6 glucoside bonds as granulation binders.

Kemeny patent application publication US 2003/0087004 is directed to sweet and savory ready to eat food bars. A bar containing oat bran, soy protein isolate and canola oil is disclosed.

Funk et al. US published patent application 20040013771 is directed to a layered cereal bar. The binder may be a complex carbohydrate binder made from soy protein, fat, sweeteners, water and gelatin. Syrup is also mentioned. “Conventional maltodextrin/fat based binders” are mentioned, as well. The sugar solution may be comprised of wet ingredients such as sugars and minor ingredients such as calcium, sorbitol, maltodextrin and salt. In one embodiment about 0.5% water is added to the sugar solution. Various flours can be included in the product. In one embodiment, the carbohydrates of the bar can comprise about 3 to 4% dietary fiber. In another, the total fiber percentage is about 5 to 10%. In one step of the binder preparation, soy protein is stirred in with a pre-heated shortening or fat. In a separate step, syrups, glycerin and sugars can be combined to form a sugar solution in a heated mixing kettle.

Wu EP 861 603 is directed to a process for coating a snack product with a heat-sensitive material and the product thereof. For savory hand held snack items, gums are said to be preferred viscosity increasing agents. Examples of hand held snack items given are granola bars, breakfast bars and cereal bars.

Wurtman et al. US patent application publication No: US 2003/0039739 is directed to a protein-free snack foodstuff having two or more rapidly digestible carbohydrates such as maltodextrin, dextrose and starch for weight loss. One of several product forms mentioned are food bars. Fiber, which may be insoluble or soluble, such as methylcellulose, psyllium and bran from oats, corn, rice, barley, buckwheat, and/or wheat may be included. Numerous other sources of carbohydrate, including dextrin, are listed. Savory flavors can be included.

Scott EP 654 223 (Unilever) discloses a hand held snack which may include particulate material such as meats of mammals, fish and poultry, and a carbohydrate binder such as various flours, gums, glucose syrup, modified starches such as Zorbit. Zorbit is believed to be a maltodextrin. The product can take the form of a snack bar.

Coleman et al. US 2004/0126477 discloses a cereal bar having a binder which includes, eg., glycerine or soribitol alone or in combination with a carbohydrate based binder such as corn syrup, corn syrup solids, molasses, honey, and the like. Suitable sweeteners which can be added include maltodextrin. Dextrin is mentioned in a discussion of a feature of the invention wherein the consumer can specify that all ingredients of a certain type, such as corn-containing ingredients, should be avoided.

Kealey et al. U.S. Pat. Nos. 6,599,553 and 6,558,713 disclose in example 18 an energy bar with maltodextrin.

Froseth et al. U.S. Pat. No. 6,592,915 is directed to a layered cereal bar. Savory flavors may be included. In one embodiment, the binder comprises, corn syrups, glycerin, sugars, (i.e., fructose, sucrose, etc.), as well as minor ingredients such as calcium, sorbitol, maltodextrin and salt.

Froseth et al. US 2002/0004749 discloses a system for selecting, ordering and distributing customized food products. Several types of customized food products are mentioned, such as “power bars.” Savory flavorings are mentioned as are maltodextrins, mentioned among carbohydrates.

Andersson WO 2004/004481 (Sudnif) is directed to a soft frozen product which may be produced as bars, balls or biscuits. Maltodextrin is mentioned as a possible stabilizer. It is said that although the products of the invention are generally sweet, savory products may be produced.

Although there have been many previous efforts to formulate nutrition and other food bars using binders, and some binders have been used as re-wetting agents, it is desirable to obtain a re-wetting agent which can be used, for example, to restore moisture to dried foods and which willl not impart an overall sweet taste.

### SUMMARY OF THE INVENTION

Applicants have discovered a wetting/re-wetting agent which can be used for savory and other non-sweet food applications. In one embodiment, the wetting agent comprises i) at least 40 wt. % or higher of solids, based on total solids in the agent, of one or more fibrous ingredient and ii) at least 1 wt. % of a compound which includes glycerol and/or fatty acid moieties. In a preferred embodiment, the fibrous compound comprises dextrin, most preferably wheat or corn dextrin. Preferably, the dextrin provides at least 40 wt. % or higher of solids, based on total solids in the wetting agent. The amount of mono- or disaccharide solids present in the wetting agent is typically limited to no greater than 10 wt. % mono- or disaccharide solids, especially no greater than 5 wt. % mono- or disaccharide solids, more preferably no greater than 2 wt. % less than 5 wt. % mono- and disaccharide solids.

In accordance with another embodiment of the invention, the wetting agent comprises one or more fibrous ingredients having fewer than 70% glucosidic 1,4 linkages, more than 15% glucosidic 1,6 linkages, especially from 25% to 50%, at least 5% each of glucosidic 1,2 linkages and glucosidic 1,3 linkages and less than 5 wt. % mono- and disaccharide solids, especially less than less than 2 wt. % mono- and disaccharide solids.

The invention is also directed to a process of preparing a wetting agent including i) at least 40 wt. % or higher of solids, based on total solids in the binder, of one or more fibrous ingredient and ii) at least 1 wt. % of a compound which includes glycerol and/or fatty acid moieties, by mixing together water, the fibrous ingredient and the glycerol and or fatty acid moieties.

The invention is also directed to process of hydrating or rehydrating a food ingredient which comprises treating the food ingredient with the rewetting agent. The invention is also directed to the hydrated or rehydrated food ingredient.

Preferably the one or more fibrous compounds used in the wetting agents according to the invention each has a glycemic index of less than 60%.

Preferred wetting agents according to comprise essentially no artificial sweeteners.

One application for the rewetting agents is in savory food bars. It is believed that many consumers wish to avoid foods having high sugar levels and prefer complex carbohydrates or other macronutrients to avoid sudden elevations in blood sugar. The prevalence of binding/re-wetting agents with substantial amounts of sugar has tended to frustrate these objectives. The savory food bar may include dried ingredients, such as vegetables or meats, which have been re-wet using the re-wetting agent of the invention, thereby avoiding some of the sugars which would be present if some prior re-wetting agents were used.

By bars herein we refer to somewhat elongated foodstuffs which retain their shape when held at one end at room temperature. We exclude from the definition of “bars” frozen products which lose their shape at room temperature.

As a wetting agent, the composition of the invention is typically applied to dried food, such as dried vegetables or dried meet, often by soaking the dried food in an excess of the wetting agent. The permits “re-wetting” of the dried food so that it is returned, more or less, to its hydrated state prior to drying. In accordance with the invention this is effected without imparting undesirable sweetness to the food.

Where used herein, “sugar solids” refers to solids contributed by mono- and disaccharides.

For a more complete understanding of the above and other features and advantages of the invention, reference should be made to the following description of the preferred embodiments

### DETAILED DESCRIPTION OF THE INVENTION

One component of the wetting agent according to the present invention is preferably added as a fiber, particularly an at least partially digestible fiber such as dextrin. It is preferred that the fibrous component of the wetting agent is stable to typical food processing conditions, e.g., it does not hydrolyze to a substantial degree to increase the sugar content, and therefore, the sweetness, of the wetting agent and ultimately of the product. Indeed, even when combined with glycerine, which has a sweet taste, sweetness has not been detected. Preferably, the fibrous component(s) of the binder/wetting agent is well tolerated by the human digestive system and has a low viscosity and is water-soluble. Indeed, the re-wetting agent should have a low viscosity at the time it is used to soak/rehydrate the dried vegetables or other food ingredient. This can be accomplished by increased temperature, e.g., to 60-70° C., or by higher moisture or glycerol content in the rewetting composition. Fibers are useful in that they may also have favorable effects on blood sugar and on beneficial microorganisms in the intestines. Nutriose® FB, available from Roquette Freres of Lestrem, France, is a preferred dextrin.

Fibers which are suitable for the present invention preferably include fewer than 70% glucosidic 1,4 linkages, especially from 20% to 60%, and more than 15% glucosidic 1,6 linkages, especially from 25% to 50%. Preferably, the fibrous component includes at least 5% each of glucosidic 1,2 linkages and glucosidic 1,3 linkages, especially from 10% to 30%.

Wheat is the preferred fiber source, although other sources such as corn may be utilized, alone or in combination. The fiber is preferably water soluble.

Ideally, the wetting agent of the invention includes few or no mono- and disacchardes. It is especially preferred that the wetting agent include less than 5 wt. % mono- and disacchardes, particularly less than 2 wt. % mono- and disaccharides and most preferably less than 0.5 wt. % mono- and disaccharides.

The fiber is typically combined with water to solubilize it and the mixture is further combined with a compound which is glycerol or which includes a glycerol moiety, such as a triglyceride. After the components have been combined to form the wetting agent, all or a portion of the water may be boiled off, as required. The wetting agent will typically comprise at least 40 wt. % solids of the fiber, from 1 to 40 wt. % of glycerol or the glycerol-moiety containing compound, from 0 to 50% water and from 0.1 to 10% minor ingredients such as salt and/or flour. More preferably, the binder/wetting agent comprises from 40-80 wt. % fiber solids, from 3 to 12 wt. % glycerol or the glycerol-moiety containing compound, from 20 to 50 wt. % water and 0.5 to 2 wt. % minor ingredients. Most preferably, the wetting agent includes from 45-55 wt. % fiber solids, from 30 to 40 wt. % water and from 0.5 to 1 wt. % minor ingredients. Preferably, the glycemic index is less than 60%, especially less than 35%.

Generally, the re-wetting agent is applied to dried food ingredients, as by soaking them. However those of ordinary skill will be able to devise alternative application techniques such as spraying or coating. Typically the dried ingredients will be savory or other non-sweet ingredients. Examples include vegetables, meats, fish, eggs, and baked goods such as crackers, shortbreads, etc. The ingredients can be dried by known processes such as freeze drying.

Use of the re-wetting fluid of the invention can restore much or all of the moisture to the dried food ingredient without adversely affecting shelf life. Application of the re-wetting liquid permits a less dry, less crunchy eating experience, while promoting shelf stability. The rewet food ingredient particles can be used in many products such as food bars, including nutritional bars, but also more generally in snacks and dry foods. Nutrition bars are food bars which have been fortified with desirable nutrients such as vitamins. In the case of bars, a binder will typically be present to ensure that the product can be shaped as a bar and can retain that shape. The binder can include the same ingredients as the rewetting agent, although normally a lower viscosity for the rewetting agent at application conditions will be preferred.

In order to improve the “bite” or “texture” of the rewet food ingredient, e.g., vegetables/meats/fish, use can be made of hydrocolloids or stabilizers, like gelatin, pectin, carrageenan, alginate, etc. If desired, the hydrocolloid can be added to the rewetting fluid. Particularly at higher moisture levels, inclusion of the hydrocolloid is believed to facilitate more effective re-hydration of the dried food ingredient. When gelatin is used as a hydrocolloid in the wetting agent, it is preferably employed at from 60 to 250 bloom strength. It may first be dissolved in water, e.g., at a temperature of 60° C. 1 part of gelatin is preferably dissolved in not less than 2 parts of water and especially 3 or more parts of water. The gelatin solution is added to the wetting agent preferably at a temperature between 40 and 80° C. If water is to be removed from the wetting agent, preferably this occurs before gelatin addition. Gelatin may be present in the wetting agent at from 0.5 to 5 wt. %, especially 1-2wt. %. Preferably, care is taken to ensure that the water activity in the rewetting fluid does not exceed the ranges mentioned elsewhere herein.

Where pectin is used as the hydrocolloid, preferably Low Methoxy Pectin is employed. LM Pectin requires calcium ions for full functionality, preferably 0.05-0.25%. High methoxy pectins are not preferred since they form gels in combination with sugars and acids. Since in the present invention sugar is kept to the lowest possible level, high methoxy pectins are considered less suitable. Pectins should be predissolved in water and brought to a boil to solubilize them sufficiently. Then the pectin solution can be added to the rewetting agent (preferably at a temperature of at least 70° C. to prevent pregelling of the pectin). If required, extra water can be boiled off from the binder/pectin mixture. The pectin content in the rewetting liquid can range from 0.2-3%.

As indicated above, the dried food ingredients which have been rehydrated in accordance with the invention can be used in a variety of foods, including food bars such as nutrition bars. The food bars may include numerous ingredients which are typically used for such products.

Typically food bars will include a binder which helps keep the ingredients together in the form of a bar. Often binders include polyols such as sugars and/or glycerol in water. The present re-hydrated food ingredients may be used in a bar comprising such binders, although given the fact that the present re-wetting agent is generally not sweet, the present re-wetting agents will more typically be used in bars which employ a binder which incorporates lower amounts of, or no, sweet tasting components. The present re-wetting agents may be suitable as such a savory, non-sweet binder, although the viscosity of the liquid may need to be adjusted upwardly for binding.

In addition to the dried food ingredients, fibers, glycerol, water and hydrocolloids as set forth herein, the food bars may include triglycerides having unsaturated fatty acid moieties as a component of the binder and/or elsewhere in the bar. Among these may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil.

The food of the invention into which the rehydrated ingredient is incorporated may include various other oils or fats as part of the binder or elsewhere within the food. In addition to those mentioned above, such oils and fats include other vegetable fat, such as for example, cocoa butter, illipe, shea, palm, palm kernal, sal, coconut, and rapeseed oils or mixtures thereof. A blend of oils (e.g., canola, soybean, or high oleic oils) may be used, especially containing either synthetic antioxidants such as BHT and/or TBHQ or natural antioxidants such as mixed tocopherols, ascorbic acid and rosemary extract or a blend of the above. When the source is for linoleic and linolenic acids (C18:2 and C18:3), straight oil or blends of oil such as canola plus soybean with an appropriate antioxidant system can be used. However, animal fats such as butter fat may also be used if consistent with the desired nutritional profile of the product. Stated more generally, where oils containing PUFA moieties are used, it is preferred that added antioxidants such as tocopherols, ascorbic acid and/or rosemary extract be present in the oil.

If desired, the food bars of the invention may include omega-3 and/or omega-6 fatty acids, as such or more usually bound to a glycerol moiety in a triacylglycerol. Among those which may be useful are included arachidonic acid, docosahexaenoic acid (DHA), eicosapentaenoic acid (EPA), lineoleic acid, linolenic acid (alpha linolenic acid) and gamma-linolenic acid.

The overall amount of fat, including any in the binder, in food bars or other foods into which the rehydrated ingredients are incorporated is not more than 45 wt. %, especially not more than 35 wt. %, preferably from 0.5 to 10 wt. %, still preferably from 0.5 to 5 wt. %.

Preferably the food bar has a water activity of 0.75 or less, preferably 0.65 or less, especially 0.6 or less.

The food bar may include protein sources. Preferred sources of protein include sources of whey protein such as whey protein isolate and whey protein concentrate, sources of rice protein such as rice flour and rice protein concentrate, and sources of pea protein. Soy protein may also be used. The protein may be present in the food in discrete nuggets, in other forms, or both in nuggets and external to nuggets.

Additional protein sources include one or more of dairy protein source, such as whole milk, skim milk, buttermilk, condensed milk, evaporated milk, milk solids non-fat, etc. The dairy source may contribute dairy fat and/or non-fat milk solids such as lactose and milk proteins, e.g. the whey proteins and caseins. Especially preferred, to minimize the caloric impact, is the addition of protein as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate. Total protein levels within the food bars of the invention or other foods into which the rehydrated ingredients are incorporated are preferably within the range of 3 wt. % to 50 wt. %, such as from 3 wt. % to 35 wt. %, especially from 3 wt. % to 20%.

When protein nuggets are employed, they typically include greater than 50 wt. % of protein selected from the group consisting of milk protein, rice protein and pea protein and mixtures thereof, especially between 51 wt. % and 99 wt. %, more preferably between 52 wt. % and 95 wt. %, most preferably 55 wt. % or above. Other ingredients which may be present in the nuggets would include one or more of other proteins, such as those listed above, lipids, especially triglyceride fats, and carbohydrates, especially starches.

Carbohydrates can be used in the food bars of the invention at levels of from 0 to 90%, especially from 1% to 49%. If the objective is a savory bar, generally mono- and disaccharides will be minimized or eliminated. Likewise, other sweet-tasting carbohydrates will also be minimized or eliminated. Apart from sweeteners and the fibers and the carbohydrate bulking agents mentioned elsewhere herein, examples of suitable carbohydrates include starches such as are contained in rice flour, flour, peanut flour, tapioca flour, tapioca starch, and whole wheat flour and mixtures thereof. The levels of carbohydrates in the food bar or other food of the invention into which the rehydrated ingredient is incorporated as a whole will typically comprise from 5 wt. % to 90 wt. %, especially from 20% to 65 wt. %.

If it is desired to include a bulking agent in the food, within or external to the nuggets, a preferred bulking agent is inert polydextrose. Polydextrose may be obtained under the brand name Litesse®. Other conventional bulking agents which may be used alone or in combination include maltodextrin, sugar alcohols, corn syrup solids, sugars or starches, subject to any desire to minimize sweet carbohydrates expressed above. Total bulking agent levels in the food bars, of the invention will preferably be from about 0% to 20 wt. %, preferably 5% to 16%.

Ingredients which may be especially suitable to the savory nature of the bar include all types of nuts, such as peanuts, pecans, walnuts, cashew nuts, macadamia nuts, and almonds, wheat nuts, pretzels, protein crisps, such as soy crisp, seeds, e.g., sunflower seeds, rolled oats, peppers such as jalapeno peppers and bell peppers, spices such as BBQ spice, chives, peanut butter, fruit pieces, such as dried cranberry, apple, etc., vegetable pieces such as rice, chips such as tortilla chips, cracker pieces, cereal such as shredded wheat, mushrooms, acidulants such as malic and citric acids and leavening agents such as sodium bicarbonate. Other ingredients, often found in non-savory bars, will typically be used judiciously, if at all. These include chocolate or compound chips or other chocolate or compound pieces, cookie and/or cookie dough pieces, such as oatmeal cookie pieces, brownie pieces, fruit jelly and honey.

Flavorings are preferably added to the food or nutrition bar in amounts that will impart a desirable flavor, e.g., a savory flavor. The flavoring may be in nuggets or external to the nuggets in the bar or other food, provided that processing is not adversely affected. Typical savory flavorings would include all kinds of vegetables, mushrooms, meat, fish, spices such as curry, etc. Other flavorings, often found in non-savory bars, will typically be used judiciously, if at all. These include varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic flavors. The nutrition bars or other foods are flavored to taste. Suitable flavorants may also include seasoning, such as salt (sodium chloride) or potassium chloride, and imitation fruit or chocolate flavors either singly or in any suitable combination. Flavorings which mask off-tastes from vitamins and/or minerals and other ingredients are preferably included in the products of the invention. Preferably, flavorants are present at from 0.25 to 3 wt. % of the food, excluding salt or potassium chloride, which is generally present at from 0 to 1%, especially 0.1 to 0.5%.

Any nuggets and the bar may include colorants, if desired, such as caramel colorant. Colorants are generally in the food at from 0 to 2 wt. %, especially from 0.1 to 1%.

If desired, the food bars, especially the nuggets, may include processing aids such as calcium chloride.

The food bars may include emulsifying agents, typical of which are phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Mono- and di-glycerides are preferred. The emulsifiers may be present in the bar and/or protein nuggets, at levels overall of about 0.03% to 0.3%, preferably 0.05% to 0.1%. Emulsifiers may be used in combination, as appropriate.

Among fiber sources which may be included in the foods of the invention either as binder or elsewhere, are fructose oligosaccharides (fos) such as inulin, guar gum, gum arabic, gum acacia, oat fiber, cellulose, whole grains, and mixtures thereof. The compositions preferably contain at least 2 grams of fiber per 56 g serving, especially at least 5 grams of fiber per serving. Preferably, fiber sources are present in the product at greater than 0.5 wt. % and do not exceed 6 wt. %, especially 5 wt. %. As indicated above, additional bulking agents such as maltodextrin, sugar alcohols, corn syrup solids, sugars, starches and mixtures thereof may also be used, subject to the desire to have an overall savory impression. Total bulking agent levels in the products of the invention, including fibers and other bulking agents, but excluding sweeteners will preferably be from about 0% to 20%, especially from 1 to 15 wt. %. The fiber and the bulking agent may be present in the food as a whole, e.g., the food bar, and/or in nuggets, etc. provided that processing is not impaired.

Carrageenan may be included in the bars or other food of the invention, internal or external to the capsules and nuggets, eg, as a thickening and/or stabilizing agent (0 to 2 wt. % on product, especially 0.2 to 1%). Cellulose gel and pectin are other thickeners which may be used alone or in combination, e.g., at 0 to 10 wt. %, especially from 0.5 to 2 wt. %.

To the extent that it is desired to include sweeteners in the savory bar of the invention, the sweetener may be included in any nuggets or elsewhere in the bar provided that it does not interfere with processing. Natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Levels of sweeteners and sugar sources preferably result in sugar solids levels of 0.1 to 15 wt. %, especially from 0.5-10 wt. %, especially 0.5 to 5 wt. % of a food bar.

It will generally be preferred that artificial sweeteners are not present where the object is a savory bar or other food product. However, if it is desired to use artificial sweeteners, these may likewise be present in a nugget and/or within the bar or other food external to the nugget, provided that it does not interfere with processing. Any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners are typically used in varying amounts of about 0.005% to 1wt. % on the bar or other food, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%, although lesser amounts may be dictated by the desire to minimize sweetness.

Since the food product of the invention is preferably a savory product wherein sweetness does not predominate, it is preferred that the product contain essentially no artificial sweeteners. “Essentially no artificial sweeteners” herein refers to that level of sweetener which does not contribute perceptible sweetness to the taste of the product. It will be recognized that this level will differ from sweetener to sweetener, particularly since certain high intensity sweeteners can impart a sensation of sweetness at very low levels.

Calcium may be present in the nutrition bars or other foods at from 0 to 100% of RDA, preferably from 10 to 30% RDA, especially about 25% RDA. The calcium source is preferably dicalcium phosphate. For example, wt. % levels of dicalcium phosphate may range from 0.5 to 1.5%. In a preferred embodiment, the product is fortified with one or more vitamins and/or minerals and/or fiber sources, in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (e.g., as Manganese Sulfate), Magnesium (e.g., as magnesium phosphate), Iron (e.g., as Ferric Orthophosphate), copper (e.g., as copper sulfate), and Zinc (as Zinc Oxide). The vitamins and minerals are preferably present at from 5 to 100% RDA, especially 5 to 50% RDA, most especially from about 15% RDA. The vitamins and/or minerals may be included within, or external to, the nuggets, provided that processing and human absorption are not impaired.

RDA as referred to herein is the Recommended Dietary Allowances 10^{th} ed., 1989, published by the National Academy of Science, National Academy Press, Washington, D.C.

The foods which incorporate the rehydrated food ingredients of the invention may be made by known methods. Ingredients are added to the foods at a convenient time in the processing, provided that any temperature sensitive ingredients are not exposed to temperatures which cause degradation of their components. Likewise, if protein-containing nuggets are present, the processor must be sensitive to any conditions which could cause degradation of the nugget.

Bars may be single extruded, coextruded or made by sheeting through a roller (Sollich).

Extruded nutritional or other food bars may be made by cooking a syrup containing liquid (at ambient temperature) ingredients and then mixing with dry ingredients. The mixture is then extruded onto a conveyor belt and cut with a cutter. Any nuggets, e.g., protein nuggets, are included among the dry ingredients. Any nuggets should only be added to the syrup when the syrup is at a temperature below that at which any of the nugget components degrade. Syrup ingredients may include components such as dextrin, corn syrup, glycerine (0-20 wt. % on total product, especially 0.5 to 10 wt. %), lecithin, water and soybean oil or other liquid oils. In addition to the nuggets, other dry components include grains, flours (e.g., rice or peanut), maltodextrin and milk powders. The rehydrated dried food ingredients according to the invention are added to the syrup as well.

Food and/or nutritional bars in the form of granola bars may be made by cooking the syrup, adding the dry ingredients and the rehydrated ingredients, blending the syrup and dry ingredients in a blender, feeding the blended mix through rollers and cutting with a cutter.

The bars of the invention may be coated, if desired, eg with milk chocolate or yogurt flavored coating. Chocolates with little or no milk or milk products may be considered so as to maximize the presence of chocolate antioxidants and, if and to the extent desired, to try to avoid reported neutralization of antioxidants in the chocolate by milk or its components.

Typically, excluding moisture lost during processing, uncoated bars will be made from 30-50 wt. % syrup, especially 35-45%, and 50-70 wt. % dry and rehydrated ingredients, especially 55-65 wt. %. Generally, coated bars will be made from 30-50 wt. % syrup, especially 35-45 wt. %, 40-50 wt. % dry and rehydrated ingredients, especially 40-45% and 0-30 wt. % coating (e.g, if appropriate, chocolate or compound coating), especially 5-25 wt. %, particularly 10-20 wt. % coating.

Nuggets may contain greater than 50wt. %, especially greater than 60%, more preferably greater than 70 or 80% of selected non-soy proteins selected from the group consisting of milk protein, rice protein and pea protein.

It can be expected that the benefits of the invention will be realized in various types of food bars, including various types of nutrition bars having vitamins and minerals including, without limitation, snack bars and meal replacement-bars. One example would be granola bars. The invention can also be expected to be useful in various other foods which incorporate ingredients which are supplied in dry form, such as meat, vegetables, fish, etc.

When used as a wetting agent, the composition of the invention may typically applied by soaking one or more of the ingredients, usually dry ingredients, in an excess of the wetting agent.

### EXAMPLE 1

A savory binder is prepared by mixing the following ingredients.

| Savory Binder | % Wgt. |
|---|---|
| Nutriose FB - Roquette | 54% |
| Distilled Water (Pure) | 36% |
| Glycerine Optim 99.7% USP DOW | 9% |
| Salt, Flour | 0.6% |

### Example 2

### Prophetic

The savory binder of Example 1 is used herein as a wetting agent. 500 liters of the wetting agent are placed in a pan. The wetting agent is heated to 60-70° C. to decrease its viscosity. Into the pan are placed ¼ pound of dried chives. The wetting agent covers the dried chives. The dried chives are left soaking in the wetting agent for 30 minutes, after which they are removed. The soaked chives are then used as such, i.e., consumed. It is found that the texture and taste of the chives are very good, much more similar to fresh chives than to dried. No sweet taste is detected. The soaked chives could also be added as such to a product such as a savory food bar.

### Example 3

### Prophetic

A savory bar having the following ingredients is prepared using the savory binder of Example 1 and the rehydrated chives of Example 2.

| Ingredient | % Wgt. |
|---|---|
| Savory Binder | 37.8% |
| Port BBQ Spice | 4.5% |
| Peanuts, Dry-Roasted | 11.0% |
| Rod God Tiny Twist Pretzels | 14.0% |
| Trisun Sunflower oil | 3.0% |
| Freeze Dried Chives | 0.30% |
| Soy crisp 80% #3191 Nuvex | 14.0% |
| AM Hulled Sunflower Seeds | 4.0% |
| Vitamin blend | 1.0% |
| Cereal, RTE, Shredd Wheat, Biscuit | 5.7% |
| Wheat Nuts | 4.0% |

Nutrients per Serving (45 g)

| Calories | 148.8 | | Fat - total | 6.4 | g |
|---|---|---|---|---|---|
| Protein | 8. | g | Saturated Fat | 0.7 | g |
| Carbohydrates | 20.6 | g | Vitamin A RE | 11.7 | mcg |
| Dietary Fiber | 6.3 | g | Vitamin C | 6.8 | mg |
| Cholesterol | 0 | mg | Sodium | 745.5 | mg |

| | | | |
|---|---|---|---|
| % Calories from fat | 33% | % Calories from carbs | 48% |

Nutrients per Serving (45 g)

| Calories | 414.5 | | Fat - total | 1.5 | g |
|---|---|---|---|---|---|
| Protein | 0.8 | g | Saturated Fat | 0 | g |
| Carbohydrates | 177.8 | g | Vitamin A RE | 0 | mcg |
| Dietary Fiber | 83.8 | g | Vitamin C | 0 | mg |
| Cholesterol | 0 | mg | Sodium | 695.7 | mg |

| | | | |
|---|---|---|---|
| % Calories from fat | 2% | % Calories from carbs | 98% |

While levels of some ingredients have been set forth for food bars, the person of ordinary skill will appreciate that these may be suitable for other foods as well.

Unless stated otherwise or required by context, the terms “fat” and “oil” are used interchangeably herein. Unless otherwise stated or required by context, percentages are by weight.

The word “comprising” is used herein as “including, but not limited to” the specified ingredients. The words “including” and “having” are used synonymously.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A hydrated food ingredient comprising a food ingredient treated with a composition comprising
a) i) at least 40 wt. % or higher of solids, based on total solids in the composition, of one or more fibrous ingredient and ii) at least 1 wt. % of a compound which includes glycerol and/or fatty acid moieties.

2. The hydrated food ingredient according to claim 1 wherein said compound includes glycerol and/or fatty acid moieties is glycerol.

3. The hydrated food ingredient according to claim 1 wherein the fibrous compound comprises dextrin.

4. The hydrated food ingredient according to claim 1 wherein said composition comprises no greater than 5 wt. % sugar solids.

5. The hydrated food ingredient according to claim 1 wherein the composition comprises essentially no artificial sweeteners.

6. The hydrated food ingredient according to claim 1 wherein dextrin provides at least 40 wt. % or higher of solids, based on total solids of the composition.

7. The hydrated food ingredient according to claim 1 wherein the one or more fibrous ingredients have fewer than 70% glucosidic 1,4 linkages, more than 15% glucosidic 1,6 linkages, at least 5% each of glucosidic 1,2 linkages and glucosidic 1,3 linkages, and said composition includes less than 5 wt. % mono- and disaccharides.

8. The hydrated food ingredient according to claim 7 wherein the composition further includes at least 1 wt. % of a compound which includes glycerol and/or fatty acid moieties.

9. The hydrated food ingredient of claim 8 wherein the one or more fibrous ingredients have a glycemic index of less than 60%.

10. Process of using a composition comprising applying to a dried food a wetting agent comprising one or more fibrous ingredients having fewer than 70% glucosidic 1,4 linkages, more than 15% glucosidic 1,6 linkages, especially from 25% to 50% and at least 5% each of glucosidic 1,2 linkages and glucosidic 1,3 linkages, the composition having less than 5 wt. % mono- and disaccharides.

11. The process according to claim 10 wherein the composition further comprises glycerol and/or triglyceride.

12. The process according to claim 12 wherein said composition includes glycerol.

13. The process according to claim 12 wherein said composition includes one or more triglycerides.

14. The process according to claim 10 wherein said one or more fibrous compounds provide at least 40 wt. % or higher of solids, based on total solids in the composition.

15. The process according to claim 12 wherein dextrin provides at least 40 wt. % or higher of solids, based on total solids in the composition.

16. A food comprising the hydrated food ingredient of claim 1.

17. The food according to claim 1 wherein the food is a food bar.

18. The food according to claim 1 wherein the food is a nutrition bar.

19. The hydrated food ingredient according to claim 1 wherein the food ingredient is a vegetable, meat, fish, egg, or baked goods or mixture thereof.
